(19) United States
(12) Patent Application Publication
(10) Pub. No.: US 2021/0217263 A1
(43) Pub. Date: Jul. 15, 2021

(54) METHOD AND A DEVICE FOR AUTHENTICATING A PERSON TO PROVIDE ACCESS OF A PREMISES

(71) Applicant: Carrier Corporation, Palm Beach Gardens, FL (US)

(72) Inventors: Sumanth Kumar Mukundala, Hyderabad (IN); Yuri Novozhenets, Pittsford, NY (US)

(21) Appl. No.: 17/123,813

(22) Filed: Dec. 16, 2020

(30) Foreign Application Priority Data
Jan. 14, 2020 (IN) 202011001704

(51) Int. Cl. G07C 9/30; G06K 9/00

(52) U.S. Cl. CPC G07C 9/30; G06K 9/00288

(57) ABSTRACT

Aspects of the invention are directed towards a device and a method for authenticating a person to provide access of a premises. One or more embodiments of the invention describe the method comprising steps of receiving one or more images of a person captured by an imaging device and determining if the person in the one or more images is an authorized person. The method further describes steps of generating credentials for allowing the person in a premises if the person in the one or more images is the authorized person. The method also describes a step of transmitting the credentials to a user device of the person to access the premises.

### CROSS-REFERENCE TO RELATED APPLICATIONS

This application claims priority to Indian Patent Application No. 202011001704, filed Jan. 14, 2020, the contents of which are incorporated by reference herein in their entirety.

### TECHNICAL FIELD OF INVENTION

The present invention generally relates to access control systems. More particularly, the invention relates to a system and a method for authenticating a person to provide access of a premises.

### BACKGROUND

Access cards are used by people, amongst other things, for accessing (i.e. to enter and/or exit) a premises. Such access cards are issued to an authorized person by an employer, a staff personnel of a hotel, an owner of a premises or by any authority of a premises. With the advancement in technology, user devices are also being used to access a premises, instead of an access card. In other words, any person having an access card or a user device can enter or exit a premises using credentials stored therein. Since the person is in possession of an access card and/or a user device to access a premises, such a person is considered to be an authorized person by default.

If an access card and/or a user device gets stolen, then they can be easily misused by an unauthorized person to access a premises. In such a situation, the unauthorized person is considered to be an authorized person as this unauthorized person is in possession of the access card and/or the user device.

People entering a premises may also be monitored using one or more imaging devices or cameras. In such a case, a dedicated individual, such as a security personnel, is required to glean through the images/video captured by the camera. Moreover, it is not possible for the security personnel to identify whether each and every person entering the premises is an authorized person.

As of now, there is no solution to automatically prevent an unauthorized person from accessing a premises. Also, there is no solution to verify if a person accessing a premises using an access card and/or a user device is an authorized person.

In view of the afore-mentioned problems, there is a need of an efficient and effective device and a method for preventing an unauthorized person from accessing a premises. There is also a need to provide a cost-effective solution for verifying if a person accessing the premises using an access card and/or a user device is an authorized person or not. In order to solve the problems in the existing solutions, a device and a method are disclosed.

### SUMMARY

Various embodiments of the invention describe a device for authenticating a person to provide access of a premises. The device comprises a receiver adapted to receive one or more images of a person captured by an imaging device and a determination unit adapted to determine if the person in the one or more images is an authorized person. The device also comprises a credential unit adapted to generate credentials for allowing the person in the premises if the person in the one or more images is the authorized person. The device further comprises a transmitter adapted to transmit the credentials to a user device of the person for accessing the premises.

In an embodiment of the invention, the transmitter is adapted to transmit the credentials to an accessing unit associated with the premises.

In a different embodiment of the invention, the user device transmits the credentials to the accessing unit associated with the premises.

In an embodiment of the invention, the accessing unit allows the person to enter the premises if the credentials received from the user device matches with the credentials received from the transmitter.

In another embodiment of the invention, the determination unit is adapted to compare the one or more images of the person with pre-stored images to determine if the person in the one or more images is an authorized person.

In yet another embodiment of the invention, a notification is transmitted to an administrator if the person in the one or more images is not an authorized person.

In another embodiment of the invention, an exit imaging device is positioned at the premises, wherein the exit imaging device transmits a deletion command to the device if the person exits the premises.

In still another embodiment of the invention, the credentials are deleted on receiving the deletion command from the exit imaging device.

In a different embodiment of the invention, the credentials are not generated if the person in the one or more images is blocked by an administrator.

In yet another embodiment of the invention, the transmitter transmits the credentials to the user device through a network. Also, the user device transmits the credentials to the accessing unit through a short-range network.

Various embodiments of the invention describe a method for authenticating a person to provide access of a premises. The method comprises steps of receiving one or more images of a person captured by an imaging device and determining if the person in the one or more images is an authorized person. The method also comprises step of generating credentials for allowing the person in a premises if the person in the one or more images is the authorized person. The method further comprises the step of transmitting the credentials to a user device of the person to access the premises.

In an embodiment of the invention, the credentials generated are transmitted by a device to an accessing unit associated with the premises.

In a different embodiment of the invention, the user device transmits the credentials to the accessing unit associated with the premises.

In yet another embodiment of the invention, the accessing unit allows the person to enter the premises if the credentials received from the user device matches with the credentials received from the device.

In an embodiment of the invention, a notification is transmitted to an administrator if the person in the one or more images is not an authorized person.

In another embodiment of the invention, an exit imaging device is positioned at the premises, wherein the exit imaging device transmits a deletion command to a device if the person exits the premises.

In yet another embodiment of the invention, the credentials are deleted on receiving the deletion command from the exit imaging device.

In a different embodiment of the invention, the credentials are not generated if the person in the one or more images is blocked by an administrator.

In another different embodiment of the invention, a computer readable medium is disclosed for authenticating a person to provide access of a premises. The computer readable medium comprises one or more processors and a memory is coupled to the one or more processors, the memory stores instructions executed by the one or more processors. The one or more processors are configured to receive one or more images of a person captured by an imaging device and to determine if the person in the one or more images is an authorized person. The one or more processors are also configured to generate credentials for allowing the person in a premises if the person in the one or more images is the authorized person. The one or more processors are further configured to transmit the credentials to a user device of the person to access the premises.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Other aspects, advantages, and salient features of the invention will become apparent to those skilled in the art from the following detailed description, which taken in conjunction with the annexed drawings, discloses exemplary embodiments of the invention.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 depicts an exemplary system architecture according to an exemplary embodiment of the invention.

FIG. 2 depicts block diagram of different components of an exemplary device according to an exemplary embodiment of the invention.

FIG. 3 depicts an exemplary flowchart illustrating a method to perform the invention according to an exemplary embodiment of the invention.

Corresponding reference numerals indicate corresponding parts throughout the drawings.

### DETAILED DESCRIPTION

Described herein is the technology with a device and a method for authenticating a person to provide access of a premises. When a person reaches a premises and tries to enter inside the premises, an imaging unit positioned at the premises may detect the person trying to enter the premises and captures one or more images of the person. Further, the imaging unit may transmit the captured one or more images to a device through a network. The device may receive the captured one or more images from the imaging unit and may determine if the person in the captured one or more images is an authorized person or not. If the device determines that the person in the captured one or more images is an authorized person, then, the device may generate and transmit credentials to a user device of the person for allowing the person to access the premises. If the device determines that the person in the captured one or more images is an unauthorized person, then, the device may transmit a notification to an administrator of the premises.

Moreover, when the user device receives the credentials from the device, the user device may transmit the credentials to an accessing unit associated with the premises. The accessing unit may further authenticate the person by matching the credentials received from the user device with credentials received from the device. For this, the accessing unit may also receive the credentials from the device after the device generates the credentials.

Also, the user device of the person and the accessing unit may communicate with each other through a bluetooth network. The person may either manually turn on the bluetooth of the user device or the user device may automatically turn on the bluetooth based on a location of the user device when the person reaches the premises.

As used herein, the premises may be a home, a building, a bank, an office, a mall, a college, a hospital and/or or any such premises. Further, the premises may have an accessing unit to provide access to the user inside the premises. Also, such a premises may be a restricted area which can only be accessed by an authorized person.

As used herein, the imaging device may be a device having a capability to detect person who is trying to enter the premises, to capture one or more images (in the form of images or video) and/or to transmit the images to a device. The imaging device may also have capability to communicate with the device through a network. In an exemplary embodiment, the imaging device may be a closed-circuit television (CCTV) camera, a smart camera or any such imaging device that is understood by a person skilled in the art. In another exemplary embodiment, the imaging device may have a sensor to detect person entering the premises. Such a sensor may be an ultrasonic sensor, a thermal sensor, a microwave detector, a pyroelectric human presence sensor, an infra-red sensor or any such sensor that is understood by a person skilled in the art.

As used herein, the device may have a capability to determine if the person is an authorized person and/or to generate and may transmit credentials to the user device of the person. The device may also have capability to communicate with the imaging device and/or the accessing unit through a network. In an exemplary embodiment, the device may be a server having processing capabilities as described herein. The server may be a cloud storage, a remote database, or any such storage known in the art.

As used herein, the user device may refer to a desktop computer or a hand-held device such as a smartphone with internet connectivity. The internet connectivity may be provided to the user device through a network. The user device may include, but is not limited to, a desktop, workstation PC, a laptop, a smart phone, a tablet, a personal digital assistance, a wearable device, or any such user device that is obvious to a person skilled in the art.

As used herein, the accessing unit may a lock or a latching device that may be associated with the premises. The accessing unit may have capability to communicate with the device, the imaging device, and/or the user device through a network. In an exemplary embodiment, the accessing unit may be a smart lock, an electronic lock, an electro-mechanical lock, a mechanical lock or any such accessing device that is understood by a person skilled in the art.

As used herein, the network may refer to a wired network, a mesh network, a long-range network or a cellular network (such as Global System for Mobile (GSM) network, a Long-Term Evolution (LTE) network, a code-division multiple access (CDMA) network, a narrow-band internet of thing (NB-IoT) technique or category M1 technique)), a short-range network (a bluetooth network, a WiFi network, or a ZigBee network, Near-field communication (NFC) technique, Radio-frequency identification (RFID) technique) or any such network/technique that is known in the art.

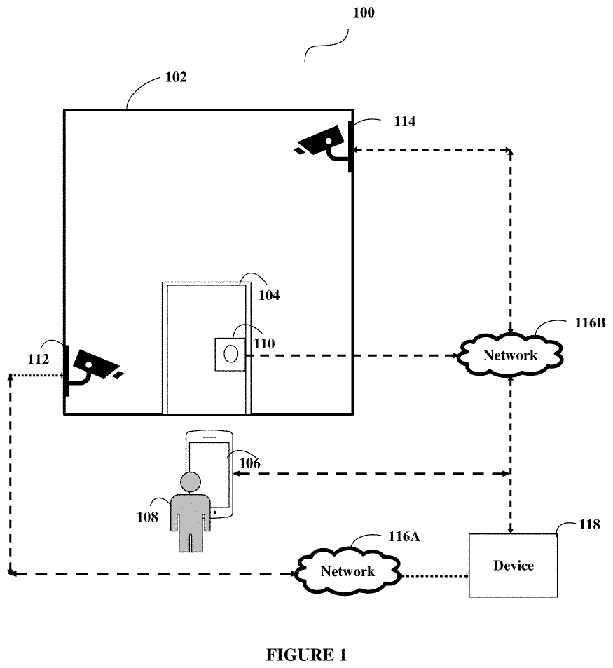

FIG. 1 depicts an exemplary system architecture 100 according to an exemplary embodiment of the invention. As depicted in FIG. 1, a premises 102 having a door 104 and an accessing unit 110 is shown. When a person 108 tries to enter in the premises 102 or reaches the premises 102, an imaging unit 112 positioned at the premises 102 may detect the person 108 who is trying to enter the premises 102. For this, the imaging unit 112 may also employ motion detection technique, object identification technique, human movement technique, human presence technique or any such technique that is well known in the art to detect the person 108 who is trying to enter the premises 102. After detecting the person 108, the imaging unit 112 may capture one or more images of the person 108. In an exemplary embodiment, the imaging unit 112 may record face of the person 108 in the one or more images. In a different exemplary embodiment, the imaging unit 112 may record a video with one or more images capturing face of the person 108. The imaging unit 112 may transmit the captured one or more images to a device 118 through a network 116A.

When the device 118 receives the one or more images from the imaging unit 112, the device 118 may determine if the person 108 captured in the one or more images is an authorized person. For this, the device 118 may have a pre-stored profile for each person, wherein each profile comprising details of a person registered/authorized to access the premises 102. The details of registered person may comprise, but is not limited to, a name of the person, an age of the person, a residential address of the person, a team/department of the person, pre-stored image/s of the person (such as facial features or in the form of facial biometric data), a unique identifier associated with a person (may be an employee ID or a student ID), and/or a unique identifier of a user device associated with the person (such as mobile number, international mobile subscriber identity (IMSI), a media access control address (MAC) etc.).

In order to determine if the person 108 captured in the one or more images is an authorized person, the device 118 may compare the captured one or more images with pre-stored images (i.e. details of each person/s authorized to access the premises 102). If the device 118 finds a match between the captured one or more images and the pre-stored images, then device 118 may determine that the person 108 captured in the one or more images is an authorized person. Further, if the device 118 does not find any match between the captured one or more images and the pre-stored images, then device 118 may determine that the person 108 captured in the one or more images is an unauthorized person. When the device 118 determines that the person 108 captured in the one or more images is an authorized person, the device 118 may generate credentials for allowing the person 108 to access the premises 102. When the device 118 determines that the person 108 captured in the one or more images is not an authorized person, the device 118 may transmit a notification to an administrator of the premises 102 for alerting the administrator. Accordingly, the administrator may take action/s. As used herein, the credentials may comprise, but is not limited to, a password, a personal identification number, a code or any such credentials that is well known in the art. As used herein, the administrator of the premises 102 may be an owner of the premises 102, a security personnel of the premises 102 or any such person. This embodiment of the invention provides a technical advantage of allowing only authorized person to access the premises 102.

Further, the device 118 may transmit the credentials to a user device 106 through a network 116B and also to an accessing unit 110 associated with the premises 102 through a network 116B. When the user device 106 receives the credentials from the device 118, the user device 106 of the person 108 may transmit the credentials to the accessing unit 110. In an exemplary embodiment, the user device 106 may transmit the credentials to the accessing unit 110 through bluetooth network, near-field communication, radio-frequency identification (RFID) technique or any such technique that is well-known in the art. In another exemplary embodiment, the person 108 may manually enter the credentials in an interface of the accessing unit 110.

On receiving the credentials from the user device 106, the accessing unit 110 may compare the credentials received from the user device 106 with the credentials received from the device 118. If the credentials received from the user device 106 matches with the credentials received from the device 118, the accessing unit 110 may provide access of the premises 102 to the person 108. And, if the credentials received from the user device 106 do not match with the credentials received from the device 118, the accessing unit 110 may provide a notification to the administrator for alerting the administrator. This embodiment of the invention provides a technical advantage of providing a three-level authentication (at the imaging unit 112, the device 108 and the accessing unit 110) for providing access of the premises 102 to the person 108. Moreover, the invention overcomes the problem of manually intensive task of identifying unauthorized persons.

Anytime after the person 108 accesses the premises 102, the person 108 may exit the premises 102. When the person 108 exits the premises 102, an exit imaging device 114 positioned inside the premises 102 may detect that the person 108 is exiting the premises 102. The exit imaging device 114 may capture images of the person 108 and may also identify the person 108. On identifying the person 108 exiting the premises 102, the exit imaging device 114 may transmit a deletion command to the device 118 through the network 116B if the person 108 exits the premises 102. Such a deletion command may be sent to the device 118 for cancelling/deleting the credentials allocated to the person 108 for accessing the premises 102. When the device 118 receives the deletion command, the device 118 may delete the credentials allocated to the person 108 for entering the premises 102. Moreover, when the person 108 again tries to enter in the premises 102, then the same procedure as explained above is repeated and new credentials will be issued to the person 108 if the person 108 is an authorized person. This embodiment of the invention provides a technical advantage of preventing an unauthorized person from accessing the premises 102 and verifying if the person 108 accessing the premises 102 is an authorized person or not.

The present invention encompasses the administrator of the premises 102 to block one or more persons from accessing the premises 102. In an exemplary first embodiment, the administrator may block a person if a person had been expelled from a company. In an exemplary second embodiment, when a person leaves or resigns from the company then the administrator may block the person. In an exemplary second embodiment, if a person has finished his/her education in a college or leaves a residential block then the administrator may block the person. Such a list of blocked person may also be maintained at the device 118. When a blocked person reaches the premises 102 and the device 118 receives images of such person from the imaging unit 112, the device 118 also may check the list of blocked person for performing authentication of such person. In this case, the device 118 may not generate credentials for accessing the premises 102 as such a person in the one or more images is blocked by the administrator. This embodiment of the invention provides a technical advantage of preventing a blocked person from accessing the premises 102.

The present invention further encompasses the administrator of the premises 102 to create a new profile at the device 118 for any expected visitor in the premises 102. To create a new profile for the visitor, the administrator may inputs details of the visitor (such as a name, age, residential address of the visitor, a team/department to be visited, image/s of the visitor (may upload image/video), a unique identifier associated with a person (may be a visitor ID), and/or a unique identifier of a user device associated with the visitor (such as mobile number, international mobile subscriber identity (IMSI), media access control address (MAC) etc.). Such profiles of the visitor may be temporary profile and may be activated only during a period of their visit in the premises 102. Through the creation of a new profile for the visitor, the device 118 may perform authentication of the visitor and may generate credentials for the visitor for allowing the visitor to access the premises 102. Also, the device 118 may consider visiting time and visiting date factors into account while performing authentication of the visitor. Such a visitor may be an interviewee, a vendor, a client or any such visitor of the premises 102. When the visitor exits the premises 102, the exit imaging device 114 may also identify the visitor and may transmit a deletion command to the device 118 through the network 116B. When the device 118 receives the deletion command, the device 118 may delete the credentials allocated to the visitor for accessing the premises 102. Moreover, the device 118 may deactivate the profile of the visitor after receiving the deletion command from the exit imaging device 114. This embodiment of the invention provides a technical advantage of authenticating the visitor for accessing the premises 102. In case where a visitor is a new joiner or a new employee, the visitor may approach a front desk/reception in the premises 102 to get an initial access (i.e. credentials) of the premises 102 and the new joiner may get registered with the device 118 (as described above) so that the new joiner can be automatically authenticated in future to get access to the premises 102. Alternatively, a visitor (in case of a serviceman or a delivery boy) may approach a front desk/reception in the premises 102 to get an initial access (i.e. credentials) of the premises 102. Then, the device 118 and the accessing unit 110 may accordingly authenticate such a visitor to provide access of the premises 102 (as described above).

Although the invention has been explained where the imaging unit 112 captures the images of the person 108 and transmit the images to the device 118 to perform authentication; however, it is also appreciated by a person skilled in the art that the imaging unit 112 may also perform authentication of the person 108 to provide access of the premises 102 as performed by the device 118. Moreover, as depicted in the FIG. 1, different networks 116A, 116B have been shown; however, it is also appreciated by a person skilled in the art that these networks 116A, 116B may be same networks as well.

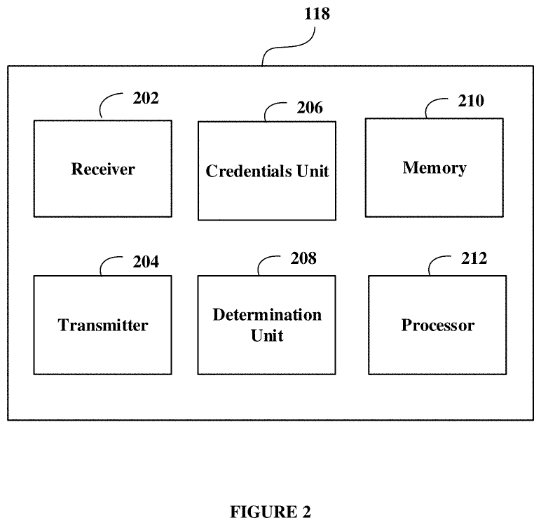

FIG. 2 depicts block diagram of different components of an exemplary device 118 according to an exemplary embodiment of the invention. The device 118 may comprise, but is not limited to, a receiver 202, a transmitter 204, credentials unit 206, a determination unit 208, a memory 210 and/or a processor 212. The receiver 202 may be adapted to receive one or more images of a person 108 from an imaging unit 112 through a network 116A. The receiver 202 may also be adapted to communicate the one or more images to the determination unit 208. The determination unit 208 may be adapted to determine if the person 108 captured in the one or more images is an authorized person by comparing the captured one or more images with pre-stored images as explained above. The determination unit 208 may also be adapted to communicate with the credentials unit 206 if the person 108 captured in the one or more images is an authorized person. Also, the determination unit 208 may also be adapted to communicate with the transmitter 204 if the person 108 captured in the one or more images is an unauthorized person. The credentials unit 206 may be adapted to generate credentials for allowing the person 108 to access the premises 102 if the person 108 captured in the one or more images is an authorized person. The transmitter 204 may be adapted to a notification to an administrator of the premises 102 if the person 108 in the one or more images is not an authorized person. The memory 210 may be adapted to store profile having details of each person, credentials generated for each person etc. Moreover, the receiver 202 may also be adapted to receive a deletion command from an exit imaging unit 114 through a network 116B when the person is exiting the premises 102.

Moreover, the receiver 202, the transmitter 204, the credentials unit 206, the determination unit 208, and/or the memory 210 may be communicably coupled with the processor 212. The different units described herein are exemplary. The invention may be performed using one or more units. For example, the tasks executed by the receiver 202, the transmitter 204, the credentials unit 206, the determination unit 208, the memory 210 and/or the processor 212 may be performed by a single unit. Alternatively more number of units as described herein may be used to perform the present invention.

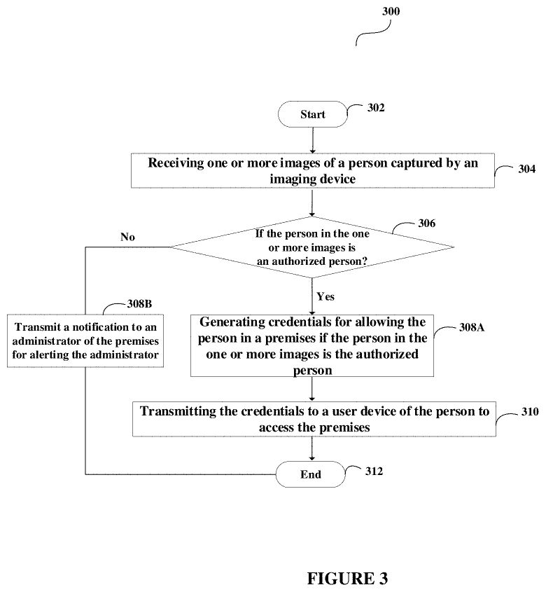

FIG. 3 depicts a flowchart outlining the features of the invention in an exemplary embodiment of the invention. The method flowchart 300 describes a method being for authenticating a person 108 to provide access of a premises 102. The method flowchart 300 starts at step 302.

At step 304, a device 118 may receive one or more images of a person 108 from an imaging unit 112.

At step 306, the device 118 may determine if the person 108 captured in the one or more images is an authorized person. For this, the device 118 may compare the captured one or more images with pre-stored images (i.e. details of each person/s registered/authorized to access the premises 102). If the device 118 finds a match between the captured one or more images and the pre-stored images, then device 118 may determine that the person 108 captured in the one or more images is an authorized person and the method 300 moves to step 308A. And, the device 118 does not find any match between the captured one or more images and the pre-stored images, then device 118 may determine that the person 108 captured in the one or more images is an unauthorized person and the method 300 may move to step 308B. At step 308B, the device 118 may transmit a notification to an administrator of the premises 102 for alerting the administrator.

At step 308A, the device 118 may generate credentials for allowing the person 108 to access the premises 102 when the device 118 determines that the person 108 captured in the one or more images is an authorized person.

At step 310, the device 118 may transmit the credentials to a user device 106 through a network 116B for allowing the person 108 to access the premises through a network 116B. Then, the method flowchart 300 may end at 312.

The present invention is applicable in various industries/fields such as, but is not limited to, banking industry, hospitality industry, building/construction industry, offices, universities, hospitals, colleges, homes and any such industry/field that is well known in the art and where the premises is a restricted area.

The embodiments of the invention discussed herein are exemplary and various modification and alterations to a person skilled in the art are within the scope of the invention.

In one embodiment of the invention, the invention can be operated using the one or more computer readable devices. The one or more computer readable devices can be associated with a device 118. A computer readable medium comprises one or more processors and a memory coupled to the one or more processors, the memory stores instructions executed by the one or more processors. The one or more processors are configured to receive one or more images of a person 108 captured by an imaging device 112 and determine if the person 108 in the one or more images is an authorized person. The one or more processors are also configured to generate credentials for allowing the person 108 in a premises 102 if the person 108 in the one or more images is the authorized person. The one or more processors are also configured to transmit the credentials to a user device 106 of the person 108 to access the premises 102.

Exemplary computer readable media includes flash memory drives, digital versatile discs (DVDs), compact discs (CDs), floppy disks, and tape cassettes. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. Computer storage media are tangible and mutually exclusive to communication media. Computer storage media are implemented in hardware and exclude carrier waves and propagated signals. Computer storage media for purposes of this invention are not signals per se. Exemplary computer storage media include hard disks, flash drives, and other solid-state memory. In contrast, communication media typically embody computer readable instructions, data structures, program modules, or other data in a modulated data signal such as a carrier wave or other transport mechanism and include any information delivery media.

Although described in connection with an exemplary computing system environment, examples of the invention are capable of implementation with numerous other general purpose or special purpose computing system environments, configurations, or devices.

Examples of the invention may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the invention may be implemented with any number and organization of such components or modules. For example, aspects of the invention are not limited to the specific computer-executable instructions or the specific components or modules illustrated in the Figures/Tables and described herein. Other examples of the invention may include different computer-executable instructions or components having more or less functionality than illustrated and described herein. Aspects of the invention transform a general-purpose computer into a special-purpose computing device when configured to execute the instructions described herein.

The order of execution or performance of the operations in examples of the invention illustrated and described herein is not essential, unless otherwise specified. That is, the operations may be performed in any order, unless otherwise specified, and examples of the invention may include additional or fewer operations than those disclosed herein. For example, it is contemplated that executing or performing a particular operation before, contemporaneously with, or after another operation is within the scope of aspects of the invention.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

In the subject specification, terms such as “data store,” “data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

When introducing elements of aspects of the invention or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C”.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A device comprising:
a receiver adapted to receive one or more images of a person captured by an imaging device;
a determination unit adapted to determine if the person in the one or more images is an authorized person;
a credential unit adapted to generate credentials for allowing the person in the premises if the person in the one or more images is the authorized person; and
a transmitter adapted to transmit the credentials to a user device of the person for accessing the premises.

2. The device of claim 1, wherein the transmitter is adapted to transmit the credentials to an accessing unit associated with the premises.

3. The device of claim 2, wherein the user device transmits the credentials to the accessing unit associated with the premises.

4. The device of claim 2, wherein the accessing unit allows the person to enter the premises if the credentials received from the user device matches with the credentials received from the transmitter.

5. The device of claim 1, wherein the determination unit is adapted to compare the one or more images of the person with pre-stored images to determine if the person in the one or more images is an authorized person.

6. The device of claim 1, wherein a notification is transmitted to an administrator if the person in the one or more images is not an authorized person.

7. The device of claim 1, wherein an exit imaging device is positioned at the premises, wherein the exit imaging device transmits a deletion command to the device if the person exits the premises.

8. The device of claim 7, wherein the credentials are deleted on receiving the deletion command from the exit imaging device.

9. The device of claim 1, wherein the credentials are not generated if the person in the one or more images is blocked by an administrator.

10. The device of claim 1, wherein the transmitter transmits the credentials to the user device through a network.

11. The device of claim 3, wherein the user device transmits the credentials to the accessing unit through a short-range network.

12. A method comprising:
receiving one or more images of a person captured by an imaging device;
determining if the person in the one or more images is an authorized person;
generating credentials for allowing the person in a premises if the person in the one or more images is the authorized person; and
transmitting the credentials to a user device of the person to access the premises.

13. The method of claim 12, further comprising: transmitting the credentials generated by a device to an accessing unit associated with the premises.

14. The method of claim 13, wherein the user device transmits the credentials to the accessing unit associated with the premises.

15. The method of claim 13, wherein the accessing unit allows the person to enter the premises if the credentials received from the user device matches with the credentials received from the device.

16. The method of claim 12, wherein a notification is transmitted to an administrator if the person in the one or more images is not an authorized person.

17. The method of claim 12, wherein an exit imaging device is positioned at the premises, wherein the exit imaging device transmits a deletion command to a device if the person exits the premises.

18. The method of claim 12, wherein the credentials are deleted on receiving the deletion command from the exit imaging device.

19. The method of claim 12, wherein the credentials are not generated if the person in the one or more images is blocked by an administrator.

20. A computer readable medium comprising one or more processors and a memory coupled to the one or more processors, the memory storing instructions executed by the one or more processors, the one or more processors configured to:
receive one or more images of a person captured by an imaging device;
determine if the person in the one or more images is an authorized person;
generate credentials for allowing the person in a premises if the person in the one or more images is the authorized person; and
transmit the credentials to a user device of the person to access the premises.
